(19) United States
(12) Patent Application Publication
(10) Pub. No.: US 2010/0292917 A1
(43) Pub. Date: Nov. 18, 2010

(54) SYSTEM AND METHOD FOR GUIDING A USER THROUGH A SURROUNDING ENVIRONMENT

(75) Inventors: Ossama Emam, La Gaude (FR); Hesham Soultan, La Gaude (FR)

Correspondence Address: Novak Druce + Quigg LLP, CityPlace Tower, 525 Okeechobee Blvd., Fifteenth-Floor, WEST PALM BEACH, FL, 33401, US

(73) Assignee: INTERNATIONAL BUSINESS MACHINES CORPORATION, Armonk, NY (US)

(21) Appl. No.: 12/465,508

(22) Filed: May 13, 2009

(51) Int. Cl. G01C 21/00

(52) U.S. Cl. 701/201

(57) ABSTRACT

A method, system and computer program product for guiding a user through a surrounding environment is disclosed. The method can include receiving user preferences; determining the current geographical location of the user, receiving a destination request from the user; creating a route for the destination; as the route is being traversed by the user, capturing images of the surrounding environment; analyzing the captured images to determine events; comparing the events to the user preferences; wherein the comparing comprises identifying at least one event matching at least one user preference; providing a notification message to the user based on the comparing step, receiving a confirmation from the user; and rendering instructions relevant to the event to the user.

### FIELD OF THE INVENTION

The present invention is related to the field of navigation devices, and more particularly to personalizing the exploration and navigation of a user through a surrounding environment.

### BACKGROUND OF THE INVENTION

It is often quite challenging for a visually impaired person to comfortably navigate through a surrounding environment. In addition to navigation, it is equally challenging to a visually impaired person to avoid obstacles on a path. A visually impaired person may well be unaware of another person approaching. Visually impaired persons may find it difficult to determine the direction in which they are travelling. Even when visually impaired persons can navigate through familiar places, they face difficulties when environmental surroundings and conditions change.

A visually impaired person is not just in need of an objective guiding navigation tool but also for a tool that can provide assistance to permit the user to fulfill the exploratory desires of the user. Current techniques disclose navigation systems but lack exploratory functionalities. The challenge remains to provide visually impaired users with the explorative freedom of a person having normal visual abilities.

### BRIEF SUMMARY OF THE INVENTION

Embodiments of the present invention provide a method, system and computer program product for guiding a user through a surrounding environment. The method can include receiving user preferences, determining the current geographical location of the user, receiving a destination request from the user, creating a route for the destination, as the route is being traversed by the user, capturing images of the surrounding environment, analyzing the captured images to extract events, using the user preferences to determine significant events, extracting information about the significant events, providing information to the user based on the significant event information and navigation instructions, and, receiving a confirmation from the user.

The method can include receiving user preferences, determining the current geographical location of the user, receiving a destination request from the user, creating a route for the destination, as the route is being traversed by the user, capturing images of the surrounding environment, analyzing the captured images to determine events, comparing the events to the user preferences, wherein the comparing comprises identifying at least one event matching at least one user preference, providing a notification message to the user based on the comparing step, receiving a confirmation from the user, and rendering instructions relevant to the event to the user.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram of an embodiment of the present invention for personalizing the exploration and navigation of a user through a surrounding environment;

FIG. 2 a schematic illustration of a data processing system for personalizing the exploration and navigation of a user through a surrounding environment; and

FIG. 3 is a flow chart illustrating a process for personalizing the exploration and navigation of a user through a surrounding environment.

### DETAILED DESCRIPTION OF THE INVENTION

Embodiments of the present invention provide a method, system and computer program product for personalizing exploration and navigation through a surrounding environment of a user, such as a visually impaired user. In accordance with an embodiment of the present invention, the system proposed by the invention is, therefore, not just a navigation tool but also a tool to consolidate image processing and navigational information with semantic characterization and customized event recognition based on user preferences.

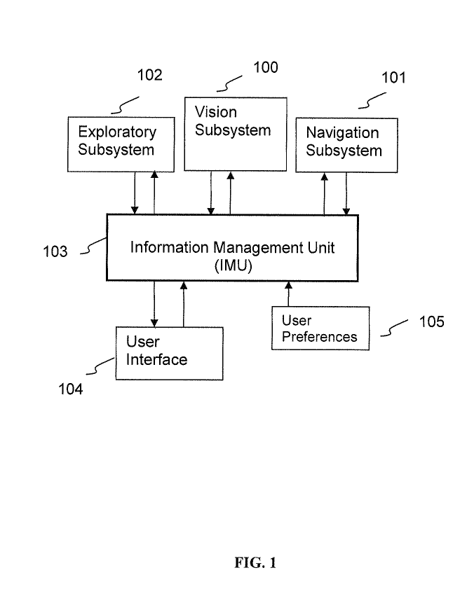

FIG. 1 is a block diagram of a brief overview of an embodiment of the present invention for personalizing the exploration and navigation of a user through a surrounding environment. A vision subsystem 100 including a camera module can be configured to capture images from the surrounding external environment, process the images to recognize objects and events based on incorporating user preferences, and analyzes the scenes to extract information about the surrounding environment. The vision subsystem 100 can send the captured surrounding environment information to a central Information Management Unit (IMU) 103. The IMU 103 can be communicatively linked to the vision subsystem 100 as well as to a navigation subsystem 101 and exploratory subsystem 102. The IMU 103 can be responsible for consolidating the information received from the vision subsystem 100, navigation subsystem 101, and exploratory subsystem 102 and share relevant information across all subsystems 100, 101, and 102. User preferences 105 are received and stored to determine which events would be of interest to the user. Significant events contained in the user preferences 105 can for example include hobbies, favorite types of food, favorite sites to visit, events buildings, people and landmarks.

After receiving surrounding environment information from the vision subsystem 100, the IMU 103 can share the surrounding environment information with the navigation subsystem 101. The navigation system 101 can utilize the surrounding environment information, in addition to the current geographical location of the user to render enhanced navigational instructions to the user. The exploratory subsystem 102 can be configured to process the surrounding environment information and utilize information extracted from the user preferences 105 to determine significant events based on the user preferences. A combination of information about the surrounding environment, navigational instructions and significant event information can be rendered to the user via the user interface 104.

The IMU 103 can include program logic enabled to receive a user profile comprising user preferences, determine the current geographical location of the user, and receive a personal request from the user. The logic can further be enabled to periodically capture images of the surrounding environment, wherein the images can be processed to produce surrounding environment information. Additionally, the logic can provide a response to the user corresponding to the personal request based on the user preferences, and receive a confirmation from the user, wherein the confirmation includes a destination location.

Furthermore, the logic can be enabled to create a route for the destination location based on the user preferences to fulfill the personal request, analyze the surrounding environment information to determine a significant event in the surrounding environment corresponding to the route that is related to at least one user preference in the user profile, and finally render navigation and exploratory instructions to the user based on the user preferences.

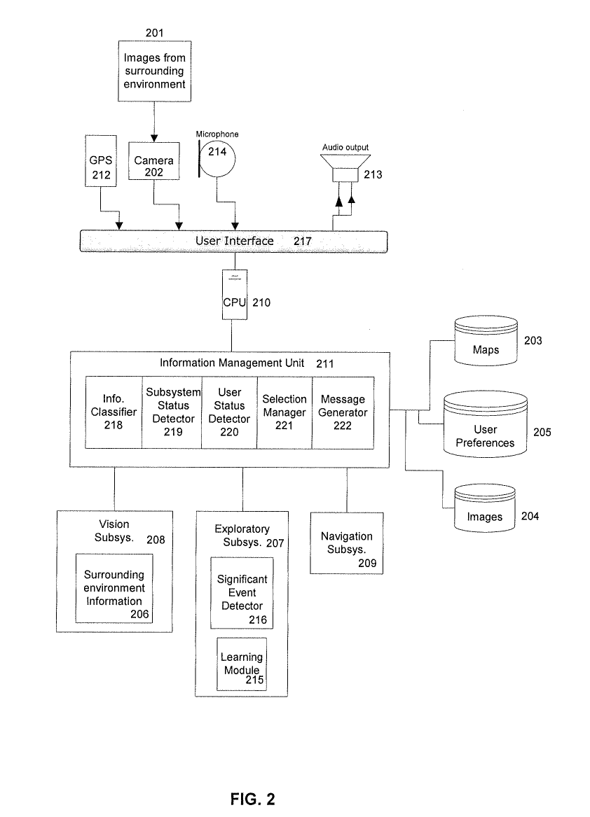

FIG. 2 is a schematic illustration of a data processing system for personalizing the exploration and navigation of a user through a surrounding environment. The system can include a camera module 202 that can continuously capture images from the surrounding environment 201 as the user is proceeding through several geographical locations. The camera module 202 can send the captured images 201 as image signals that can be further analyzed by a host computing platform, such as a central processing unit (CPU) 210, which can host the IMU 211. The input means 214 utilized by the user to interact with the user interface 217 can include inputting personal requests by microphone, keyboard, or any pointing or other suitable device to navigate through pre-defined menus. Other alternative technologies can be employed to enhance the user interface 217. For example, a semantic automatic speech recognition (ASR) module can be configured to accept voice input. For a full interactive system, the semantic ASR module can be coupled with a Text-To-Speech module and a dialog manager to employ a dialog-based system. The dialogue manager can be configured to extract information from the user. The invention can include programs where multiple people can input information or provide inputs to the system at the same time.

The vision subsystem 208 can analyze the image signals and compare them to existing images in the images database 204; or can otherwise analyze the images using image analysis software. The analyzed images can provide surrounding environment information 206 which can be utilized by the navigation subsystem 209 and exploratory subsystem 207 in rendering navigational information and significant event information to the user. Surrounding environment information 206 can include information about persons that are identified using visual face detection and recognition methodology, or information about objects that are identified using object recognition techniques. Additionally, surrounding environment information 206 can include information about shops, streets and signs that are identified using optical character recognition. Alternatively, other image processing techniques can be utilized to recognize weather conditions and illumination conditions.

The navigation subsystem can determine navigation information for a given user request, such as a request for a destination, based on surrounding environment information. The navigation subsystem can use the surrounding environment information 206, the location information, and data from maps database 203 to prepare navigational information to the user. A Global Positioning System (GPS) 212 can locate the current geographical location (x, y position) of the user. The navigation subsystem can be configured for determining navigational information of a destination location based on the current geographical location of the user, the personal request of the user, and the surrounding environment information provided by the vision subsystem.

The exploratory subsystem 207 can include a learning module 215 and a significant event detector 216 module. The exploratory subsystem 207 can process the surrounding environment information 206 to determine significant events that might be of interest to the user. A significant event detector module 216 can determine significant events utilizing a user model created by the learning module 215 and the surrounding environment information 206 provided by the vision subsystem 208. The significant event detector module 216 compares and processes the surrounding environment information 206 with the user preferences 205 to determine where a match exists, that is, where an event in the surrounding environment would be of interest to the user based on identifying relevant user preferences.

The significant event detector module 216 can be programmed to determine direct matches between an event in the surrounding environment and a user preference, and can also be programmed with the learning module 215 to detect where an event might relate to a user preference while not explicitly matching it. A significant event can be a building, object, or person that has significance to the user. An event can be recognized as significant based on a methodology which compares the surrounding environment information 206 and the user preferences 205 in the user profile, and concludes that the event has personal value to the user based on the user preferences 205. The significant event detector module 216 can be configured as a statistical classifier that is trained to detect significant events using manually labeled training data.

Additionally, a communication module can be incorporated into the system to access supplementary information about possible points of interest and additional events, such as online tourist materials or information concerning the user's location. The significant event detector module 216 can extract the supplementary online information about possible events or points of interest, as well as consult the user model created by the learning module 215 to further enhance the determination of significant events for a specific user.

The IMU can include other modules working in conjunction with the exploratory subsystem 207, the vision subsystem 208, and the navigation subsystem 209 to maintain surrounding environment information, navigational information and significant object information which can be rendered to the user through any suitable output means 213 such as a microphone or speaker device. The IMU can include an information classifier module 218 that can be configured for classifying user preferences and subsystem information, based on a predefined set of features that are supplied by each subsystem. For instance, the vision subsystem 208 can provide surrounding environment information 206 that is tagged with a set of features or tags for later use by the exploratory and navigation subsystems. For example, the vision subsystem 208 can be configured to detect and recognize a person. The recognition information about the person detected can be processed by the IMU and provided in the following structure:
subsystem=‘vision’
environment=‘person’
subsystems to inform=‘navigation and exploratory’
   The IMU can also include a subsystem detector module 219 that can be configured for detecting the status of each of the exploratory subsystem 207, the vision subsystem 208, and the navigation subsystem 209. The IMU can also include a user status detector module 220 that can be configured for detecting the status of a user.

The IMU can further include a selection manager 221 can be provided for selecting navigation information and significant event information depending on the status of the exploratory subsystem 207, the vision subsystem 208, and the navigation subsystem 209 provided by the subsystem status detector 219 and the user status provided by the user status detector 220. A message generator 222 can be configured to render both exploratory and navigational information through output means 213, such as an audio output device. The selection manager 221 can give priority to or interrupt a subsystem based on whether the user needs urgent navigational instructions to avoid a hazardous situation or exploratory information.

For instance, in situations where a user is about to cross a traffic light or face an obstacle, the selection manager 221 can give priority to rendering urgent navigational instructions to assist the user. However, in situations where the user is merely walking in a safe pedestrian path, priority is given to rendering significant event information, such as informing the user that the user is encountering a coffee shop and rendering information about the coffee shop. The significant event information can be determined based on comparing the surrounding environment information 206 and the user preferences 205 in the user profile, and concluding that the event has personal value to the user based on the user preferences 205.

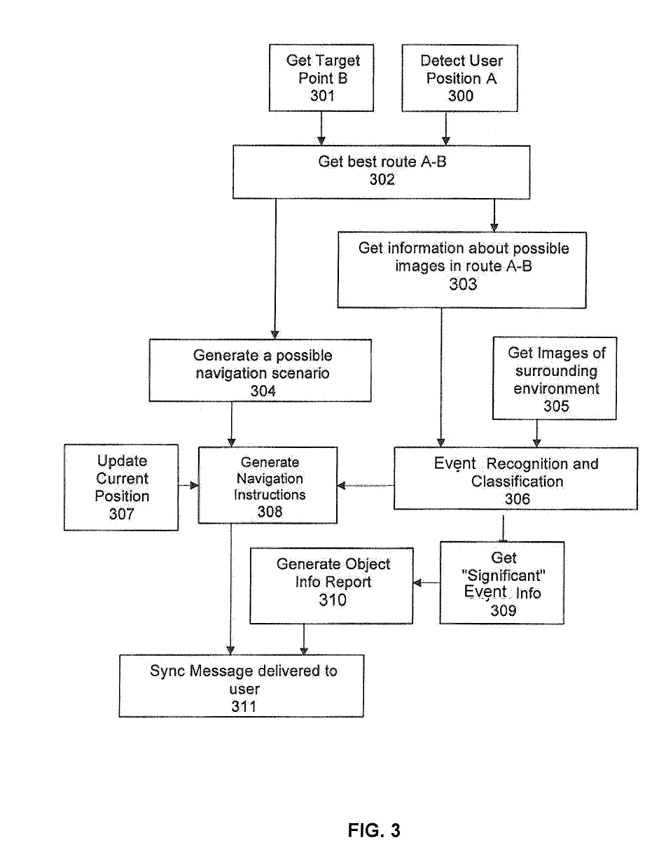

FIG. 3 is a flow chart illustrating a process for personalizing the exploration and navigation through a surrounding environment by a user. In one embodiment, a user wishing to move from point A to point B and additionally wishing to discover events along the route can utilize the system through the user interface. The process can begin in block 300 by determining the current geographical location of the user (point A). The geographic location can be determined by GPS or similar locating devices. Next in block 310, the system can receive a destination request as an input from the user. The selection of the destination location can be made by the user using any means of input such as the user's voice. The speech recognition system 207 and the dialogue manager 215 can be used to extract information about the destination location from the user. A destination request can be a geographical location, and/or can include a remark related to the current status, mode or wish of the user, such as “I'm hungry,” from which a destination location can be determined. The final selection of the destination location (point B) is determined via the system.

Alternatively (not shown in FIG. 3), the system can search and extract predefined user preferences from the user preferences database 205. The user preferences can be stored in the data store or extracted through a social network profile of the user which contains information about the user, such as hobbies and interests. Based on the user preferences, the system can intelligently recommend a suitable option or destination location that can fulfill the initial request. For example, based on the user's initial request being “I'm hungry”, the system can extract the user preferences to determine the user's favorite types of food. For example, if “Egyptian food” is listed in the user preferences as favorite types of food, then the system can recommend an Egyptian restaurant responding as “I know that you like Egyptian food, would you like to go to the nearest Egyptian restaurant?” Thereafter, the system can determine whether the user confirms the recommendation response by the system. A positive confirmation can preferably include a destination location, such as “Yes” or “Egyptian restaurant.” If the user does not agree, then the system can wait on receiving additional inputs from the user until a destination is confirmed. If the system receives a positive confirmation from the user, the requested destination can be determined by looking up the address from the maps database 203. Next a route can be created based on the user preferences. For example, if the destination location is the nearest Egyptian restaurant, then a route can be created not only based on the destination location but also based on the user preferences such as whether the user has indicated in the user preferences whether he/she enjoys “walking through parks” or “avoiding busy streets.” Thus, the route created can be customized based on the user preferences and the system can render instructions to the user. The instructions can include not only navigational instructions for the destination location, but can also supplement the navigational instructions with information to the user regarding upcoming attractions or objects the user may have interest in, based on comparing or analyzing objects using the user preferences.

Continuing with FIG. 3, once the destination has been confirmed, the system can create a route in block 302 from the current geographical location of the user (point A) to the destination (point B) using the maps database 203. In block 303, the system can utilize the route information to extract images from the images database 204 that will most likely be passed by during the journey. The system can also utilize the route information to generate a possible navigation scenario in block 304. Images of the surrounding environment are also captured periodically by the system in block 305. In block 306, the system can utilize information about possible images in the route from block 303 in addition to incorporating the images captured from the surrounding environment in block 305 in order to recognize significant events. Events can be classified as “significant” if they are not seen before or in the list of predefined events. A significant event can be a building, object, or person that has significance to the user. An event can be recognized as significant based on a methodology which compares the surrounding environment information 206 and the user preferences 205 in the user profile, and concludes that the event has personal value to the user.

Alternatively (not shown in FIG. 3), events tagged as “significant” can include events directly along the route, or in the vicinity of the route which the system can calculate based on a predefined radius. For example, if the user has indicated in the user preferences that the user prefers exploring points of interest that are no more than 700 feet in distance from the route, the system can tag significant events within 700 feet from the current location of the user. Additionally, significant events do not necessarily have to be an exact key word match from the user preferences. The system can determine nearest relevant matches. For example, if the user preferences indicate that the user enjoys desserts, the system can recommend to the user an ice cream store that is nearby. If the user has indicated “Chinese food” in the user preferences, the system can attempt to ask the user whether the user would be interested in “Japanese food” if a Chinese restaurant is not close by. If the events recognized are related to the user preferences, then events can be tagged as “significant.” Determining whether the events recognized from the images are related or relevant to the user preferences can be calculated by matching or otherwise associating the user preferences to the recognized event. Messages consisting of navigational instructions and exploratory event information can be delivered to the user. For example, if the image is recognized by the system as a “statue” located in a park corresponding to the route and if according to the user preferences “statues” or “art objects” are indicated as of interest to the user, then the system can recommend and provide information concerning the “statue” as well as provide navigational instructions to that object.

Continuing with FIG. 3, in block 307, the current position of the user can be continuously updated. In block 308, the system can utilize the information about the current position as well as the recognized events to generate navigational instructions. In block 309, events that are classified as significant can be searched and explored to extract more data and information about them. In block 310, an information report about significant objects can be generated.

Finally in block 311, messages can be rendered to the user consisting of navigation instructions and exploratory information, including significant event information. It is important to note that if the user must currently cross a traffic light or face an urgent obstacle, priority of the instructions can be given to the navigational instruction to direct the user according to a safe or safer path. In situations where the user is already walking in a safe path, and happens to be approaching a possible point of interest or significant object recognized by the exploratory subsystem, such as a statue, the system can render information about the statue to the user based on identifying statues listed in the user preferences of the user profile. Thus, the system can take into account the current position, surrounding environment information, user preferences, as well as the event recognition in order to generate both exploratory and navigational instructions to the user.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A computer-implemented method for guiding a user through a surrounding environment, the method comprising:
receiving user preferences;
determining the current geographical location of the user;
receiving a destination request from the user;
creating a route for the destination;
as the route is being traversed by the user, capturing images of the surrounding environment;
analyzing the captured images to determine events;
comparing the events to the user preferences, wherein the comparing comprises identifying at least one event matching at least one user preference;
providing a notification message to the user based on the comparing step;
receiving a confirmation from the user; and
rendering instructions relevant to the event to the user.

2. The method of claim 1, further comprising assigning priority to rendering emergency navigational instructions to assist the user in an emergency.

3. The method of claim 1, wherein the instructions rendered to the user comprise navigational instructions to the event related to the at least one user preference.

4. The method of claim 2, further comprising recalculating the route from the geographical location of the event to the destination.

5. A data processing system for guiding a user through a surrounding environment, comprising of:
means for receiving user preferences;
means for determining the current geographical location of the user;
means for receiving a destination request from the user;
means for creating a route for the destination;
as the route is being traversed by the user, means for capturing images of the surrounding environment;
means for analyzing the captured images to determine events;
means for comparing the events to the user preferences, wherein the comparing comprises identifying at least one event matching at least one user preference;
means for providing a notification message to the user based on the comparing step;
means for receiving a confirmation from the user; and
means for rendering instructions relevant to the event to the user.

6. The system of claim 5, comprising:
a central processing unit configured for execution in a host computing platform;
a memory subsystem coupled to the central processing unit;
a user interface coupled to a geographical location detection device and a camera;
an vision subsystem configured for capturing images from a surrounding environment and processing said captured images to provide surrounding environment information;
an exploratory subsystem configured for determining event information related to events in said surrounding environment that relate to user preferences in a user profile, said exploratory subsystem comprising a learning module and a significant event detector module for detecting said events using said surrounding environment information provided by said vision subsystem and said user preferences;
a navigation subsystem for determining navigation information based on said surrounding environment information provided by said vision subsystem and location information related to a current location of said user; and,
an information management unit logic coupled to the central processing unit, the logic comprising program code enabled to receive user preferences, determine the current geographical location of the user, receive a personal request from the user, periodically capture images of the surrounding environment, wherein the images comprise surrounding environment information, provide a response to the user corresponding to the personal request based on the user preferences, receive a confirmation from the user, wherein the confirmation includes a destination location, create a route for the destination location based on the user preferences to fulfill the personal request, analyze the surrounding environment information to determine an event in the surrounding environment corresponding to the route related to at least one user preference, and render exploratory and navigational instructions to the user based on the user preferences.

7. The system of claim 5, wherein the instructions comprise navigational instructions to the event.

8. The system of claim 7, further comprising means for recalculating the route from the geographical location of the event to the destination location.

9. The system of claim 5, further comprising assigning priority to rendering emergency navigational instructions to assist the user in an emergency.

10. A computer-readable storage having stored thereon a computer program having a plurality of code sections executable by a machine for causing the machine to perform a method for guiding a user through a surrounding environment, the method comprising the steps of:
receiving user preferences;
determining the current geographical location of the user;
receiving a destination request from the user;
creating a route for the destination;
as the route is being traversed by the user, capturing images of the surrounding environment;
analyzing the captured images to determine events;
comparing the events to the user preferences, wherein the comparing comprises identifying at least one event matching at least one user preference;
providing a notification message to the user based on the comparing step;
receiving a confirmation from the user; and
rendering instructions relevant to the event to the user.

11. The computer-readable storage medium of claim 10 wherein the instructions comprise navigational instructions to the event.

12. The computer-readable storage medium of claim 11, further comprising recalculating the route from the geographical location of the event to the destination location.

13. The computer-readable storage medium of claim 10, further comprising assigning priority to rendering emergency navigational instructions to assist the user in an emergency.
